(19) United States
(12) Patent Application Publication
(10) Pub. No.: US 2018/0246695 A1
(43) Pub. Date: Aug. 30, 2018

(54) INDIVIDUALLY CUSTOMIZED AUTOMATED MEDIA CONTENT FILTERING

(71) Applicant: Hosea Taylor, Cincinnati, OH (US)

(72) Inventor: Hosea Taylor, Cincinnati, OH (US)

(21) Appl. No.: 15/811,631

(22) Filed: Nov. 13, 2017

Related U.S. Application Data
(60) Provisional application No. 62/464,032, filed on Feb. 27, 2017.

(51) Int. Cl. G06F 3/16; G06F 3/0482; G06F 17/24

(52) U.S. Cl. CPC G06F 3/165; G06F 17/24; G06F 3/0482

(57) ABSTRACT

A system, method and electronic device filter objectionable material from media content according to individual customizable selections. The electronic device includes an interface that receives selected media content. A user interface device presents selected media content. A processor subsystem is in communication with the interface and the user interface device. The processor subsystem selects media content for presentation on the user device, the selected media content contains a selected at least one of: (i) words and (ii) images. The processor subsystem associates a user of the user device with a selected one or more objectionable items. The processor subsystem identifies at least one instance of a selected objectionable item. The processor subsystem obscures presentation of the selected objectionable item during presentation of the selected media content without altering any recorded version of the selected media content. User selections can be remotely maintained and used for processing other media content on other user devices.

### CLAIM OF PRIORITY UNDER 35 U.S.C. § 119

The present Application for Patent claims priority to Provisional Application No. 62/464,032 entitled “Individually Customized Automated Media Content Filtering” filed Feb. 27, 2017, and hereby expressly incorporated by reference herein.

### FIELD OF THE INVENTION

The present disclosure generally relates to interactive editing of audiovisual media content, and more particularly to a consumer customized presentation of audiovisual media on a user device.

### BACKGROUND OF THE INVENTION

Consumers are presented with a vast array of audiovisual media content including songs, videos, electronic books, movies, audiobooks, etc. The expressions in this content can range from the sublime to the pornographic or otherwise objectionable. A significant number of users would like to consume a wider offering of such content without having to be personally subjected to the occasional or pervasive inclusion of objectionable words or images. Past attempts to curtail objectionable content for a significant subset of the public have included creating a derivative work of the original that removed or obscured categories of content such as profane and vulgar words, nude images, and pornographic content. However, copyright statutes give the owner of copyrighted works the rights related to creating derivative works. As such, sensitive consumers generally do not have access to such edited versions of media content unless the copyright owner has individually authorized such products.

### SUMMARY OF THE INVENTION

In one aspect, the present disclosure provides a method includes selecting media content for presentation on a user device, the selected media content contains a selected at least one of: (i) words and (ii) images. Method includes associating a user of the user device with a selected one or more objectionable items. Method includes identifying at least one instance of a selected objectionable item. Method includes obscuring presentation of the selected objectionable item during presentation of the selected media content without altering any recorded version of the selected media content.

In another aspect, the present disclosure provides an electronic device that includes an interface that receives selected media content. A user interface device presents selected media content. A processor subsystem is in communication with the interface and the user interface device. The processor subsystem: (a) selects media content for presentation on the user device, the selected media content contains a selected at least one of: (i) words and (ii) images; (b) associates a user of the user device with a selected one or more objectionable items; (c) identifies at least one instance of a selected objectionable item; and (d) obscures presentation of the selected objectionable item during presentation of the selected media content without altering any recorded version of the selected media content.

In an additional aspect, the present disclosure provides a system having a network repository that contains: (i) an application store containing a downloadable end user application; and (ii) a database of identified users associated with selections of individually-identified objectionable content. The system includes a network in communication with the network repository and in communication with one or more sources of media content. The system includes an electronic device of one or more electronic devices associated with a selected user. The electronic device includes an interface that receives selected media content. A user interface device presents selected media content. A processor subsystem is in communication with the interface and the user interface device. The processor subsystem: (a) selects media content for presentation on the user device, the selected media content contains a selected at least one of: (i) words and (ii) images; (b) associates a user of the user device with a selected one or more objectionable items; (c) identifies at least one instance of a selected objectionable item; and (d) obscures presentation of the selected objectionable item during presentation of the selected media content without altering any recorded version of the selected media content.

These and other features are explained more fully in the embodiments illustrated below. It should be understood that in general the features of one embodiment also may be used in combination with features of another embodiment and that the embodiments are not intended to limit the scope of the invention.

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 illustrates a block diagram of a communication system including an individually customizable audiovisual editor to obscure objectionable content, according to one or more embodiments;

FIG. 2 illustrates a front view of an electronic device displaying media content that is user customizable to block objectionable content, according to one or more embodiments;

FIG. 3 illustrates a front detail view of the electronic device continuing playback while obscuring objectionable content both visually and aurally, according to one or more embodiments;

FIG. 4 illustrates a temporal graph of word content of media content displayed on an electronic device, according to one or more embodiments;

FIG. 5 illustrates a front view of an electronic device displaying an obscured objectionable image identified by a user, according to one or more embodiments;

FIG. 6 illustrates a front view of the electronic device continuing to display the obscured objectionable image, according to one or more embodiments;

FIG. 7 illustrate a flow diagram of a method of customizing audiovisual media content to obscure objectionable content, according to one or more embodiments; and

FIG. 8 illustrate a flow diagram of a method of further customizing audiovisual media content to obscure objectionable content, according to one or more embodiments.

### DETAILED DESCRIPTION

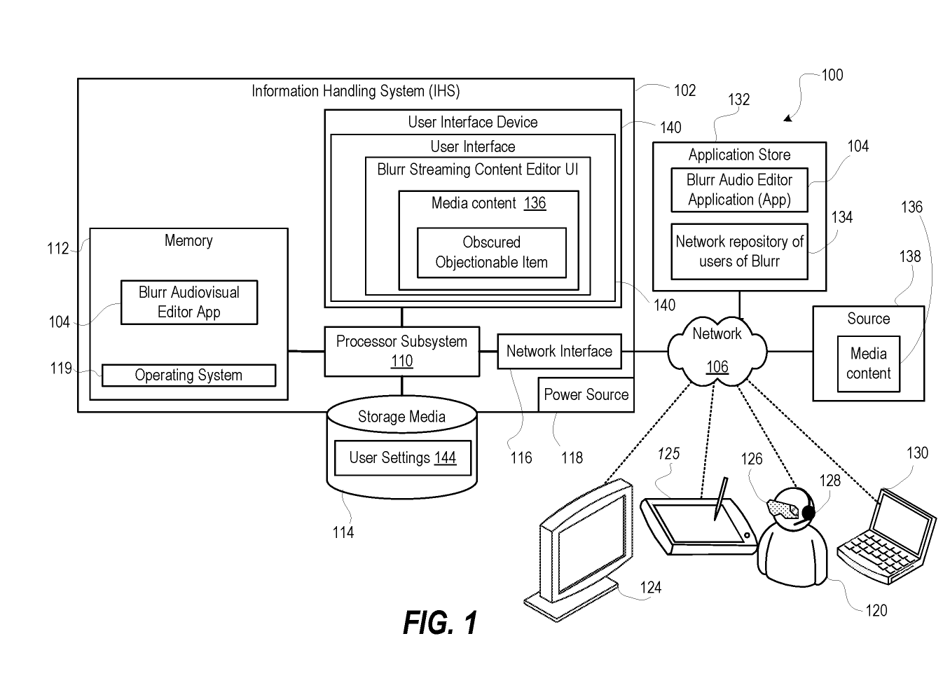

FIG. 1 illustrates a communication system 100 including an information handling system (IHS) 102 for executing a blur audiovisual editor application 104 at least in part over a network 106. For purposes of this disclosure, an information handling system, such as IHS 102, may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a handheld device, personal computer, a server, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components. The processing function may be implemented in software, hardware, or a combination thereof

In a particular embodiment, the IHS 102 includes a processor 110, a memory 112 communicatively coupled to processor subsystem 110, storage media 114, a network interface 116 communicatively coupled to processor subsystem 110, and a power source 118 electrically coupled to processor subsystem 110. Processor subsystem 110 may include any system, device, or apparatus configured to interpret and/or execute program instructions and/or process data, and may include, without limitation a microprocessor, microcontroller, digital signal processor (DSP), Application Specific Integrated Circuit (ASIC), or any other digital or analog circuitry configured to interpret and/or execute program instructions and/or process data such as an operating system 119. In some embodiments, processor 110 may interpret and/or execute program instructions and/or process data stored in memory 112 and/or another component of IHS 102. Memory 112 may be communicatively coupled to processor 110 and may include any system, device, or apparatus configured to retain program instructions and/or data for a period of time (e.g., computer-readable media). By way of example without limitation, memory 112 may include RAM, EEPROM, a PCMCIA card, flash memory, magnetic storage, opto-magnetic storage, or any suitable selection and/or array of volatile or non-volatile memory that retains data after power to IHS 102 is turned off or power to IHS 102 is removed. Network interface 116 may include any suitable system, apparatus, or device operable to serve as an interface between IHS 102 and network 106. Network interface 116 may enable the IHS 102 to communicate over network 106 using any suitable transmission protocol and/or standard, including without limitation all transmission protocols and/or standards enumerated herein with respect to the discussion of network 106.

A user 120 can use one or more electronic devices 122, such as a television monitor 124, a tablet or smartphone device 125, augmented or virtual reality goggles 126, headphones 128 and personal computing workstation 130. Each can perform some or all of the processing as the IHS 102. In some instances, a remote IHS 102 performs distributed processing. Each of the electronic devices 122 and IHS 102 can be provisioned with the blurr audiovisual editor application 104 or download a copy from an application store 132. The application store 132 can also maintain a network repository 134 that contains a database of identified users associated with selections of individually-identified objectionable content. Thereby, user devices 122 can be enabled with previously customized user settings 144 for a particular user. Electronic devices 122 can also be provisioned with media content 136 or download media content 136 from a source 138 over the network 106. Alternatively or in addition, customization as user settings 144 can be locally stored in storage media 114.

In addition, the user 120 of the device 122 may be enabled to provide personalized configurations to be provided to the device 122 of the user 120. The personalized configurations may include types of content for which the user 120 desires to obscure. In the preferred embodiment, the types of content for which the user 120 desires to obscure includes one or more types of objectionable content such as, for example, profane language, violent content, scary content, sexual situations, or the like. As such, hereinafter, the content for which the user 120 desires to obscure is referred to as objectionable content. However, the present invention is not limited to obscuring objectionable content.

In one embodiment, the user 120 is enabled to select one or more types of objectionable content for which to obscure from a list of predefined objectionable content types such as, for example, profane language, violent content, scary content, sexual situations, or the like. In addition or alternatively, the user 120 may be enabled to define customized objectionable content types by, for example, entering one or more keywords, selecting one or more keywords from a list of predefined keywords, or the like. In an alternative embodiment, the types of objectionable content may be predefined and non-configurable by the user 120. In addition to defining the types of objectionable content, the personalized configurations of the user 120 may define desired attributes of the media alteration. The desired attributes may include, for example, an amount of time between when an obscures presentation is to be provided to the device 122 and playback of the objectionable content. The desired attributes may also include attributes defining information to be provided in the advance content alerts such as a preview of the objectionable content, information describing or identifying the objectionable content, or the like.

The personalized configurations may also include configurations defining when obscured presentations are to be provided to the device 122. More specifically, the personalized configurations may define a time period during the day when the obscured presentations are or are not to be provided, one or more days of the week on which the advance content alerts are or are not to be provided, or the like. For example, the personalized configurations may be defined such that obscured presentations are provided to the device 122 of the user 120 only during the hours of 5 PM to 9 PM when it is likely that the user 120 and his children will be viewing or listening to media items played by the devices 122. The personalized configurations may also be defined such that the obscured presentations are only to be provided to the device 122 when another defined user, or mobile device of another defined user, is nearby, such as within a local wireless communication range of the device 122. The personalized configurations may also define default actions to take in response to obscured presentations for one or more of the defined types of objectionable content for which the user 120 desires an obscured presentation.

The processor subsystem 110 of the IHS 102 or electronic device 122 selects media content 136 for presentation on a user interface device 140. The selected media content 136 contains a selected at least one of: (i) words and (ii) images. The processor subsystem 110 associates a user 120 of the electronic device 122 with a selected one or more objectionable items. The processor subsystem 110 identifies at least one instance of a selected objectionable item; and (d) obscures presentation of the selected objectionable item during presentation of the selected media content without altering any recorded version of the selected media content.

In one or more embodiments, In one or more embodiments, a server can receive media content from one or more media content sources. For example, media content can be uploaded from end-user sources. In another example, media content items can be received from one or more media sources, such as sources of broadcast programming or video-on-demand (VOD) programming. In another embodiment, media content, such as video, audio, and/or still images can be received from a social networking system or site. In one embodiment, the media content can be stored at a local storage device or a connected media server. In one embodiment, the media content is uploaded to the memory of an electronic device where it can be accesses by the IHS. In one embodiment, the storage device can store the media content as cloud accessible content on a server. In one embodiment, the media content is accessed by the IHS without alteration of the original copy of the media content.

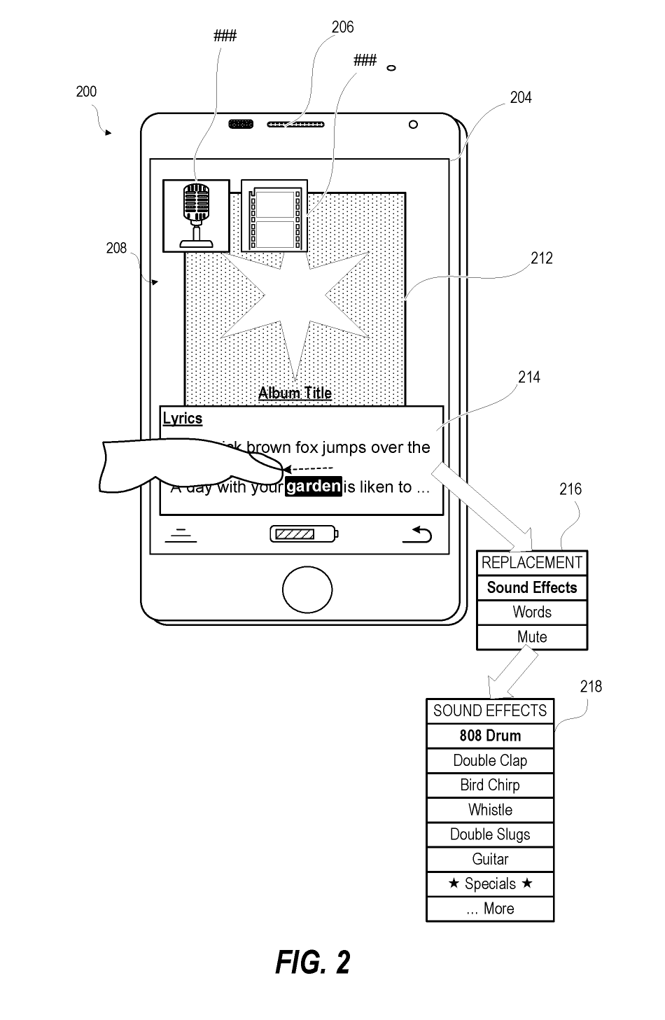

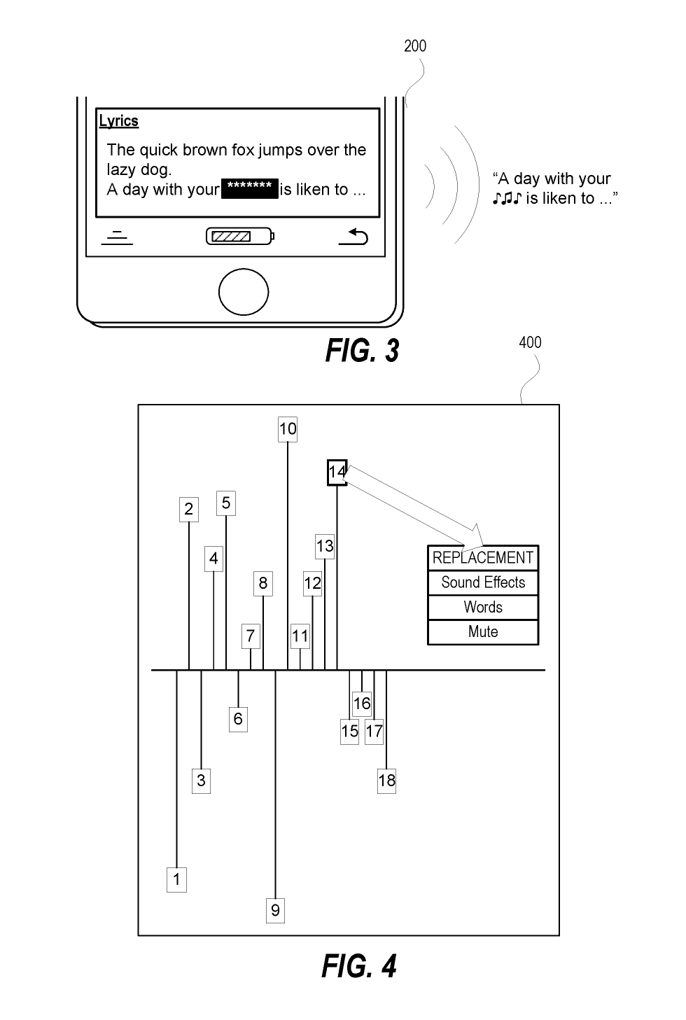

FIG. 2 illustrates an illustrative electronic device 200 having a user interface device 202 that includes a visual display 204 and a speaker 206. Affordances 208 can be presented such as visually or aurally to solicit user inputs. For example, a music icon 210 can activate blurr audiovisual editing on song or spoken word content of an electronic book. For another example, a video icon 212 can activate blurr audiovisual editing on audiovisual content such as a movie. FIG. 2 illustrates displaying an album cover 212, playing audio music, and displaying text of lyrics 214 of the song. A user has selected the word “garden” as being objectionable, triggering first hierarchical affordance 216 for selecting how to obscure instances of the objection item “garden”, such as by using sound effects, alternate words, or muting. Selecting a higher tier option triggers a next level affordance 218 of types of sound effects. FIG. 3 illustrates the electronic device 200 continuing playback while obscuring objectionable content both visually and aurally. In one embodiment, the segment of a video including violence, nudity, or the like, system may provide the user 120 with the option of skipping the objectionable content or replacing the objectionable content with an advertisement.

FIG. 4 illustrates a temporal waveform 400 presented by an electronic device 400 as a secondary audio editing ability. For example, the media content may not previously translated into accompanying text words. Translating on the fly may be deemed too difficult due to the quality of the recording or impose too high of a processing burden on the device. Instead, by counting the words that cannot be made out as a lyric/word/subtitles, etc., a user can pinpoint the word that is to be removed.

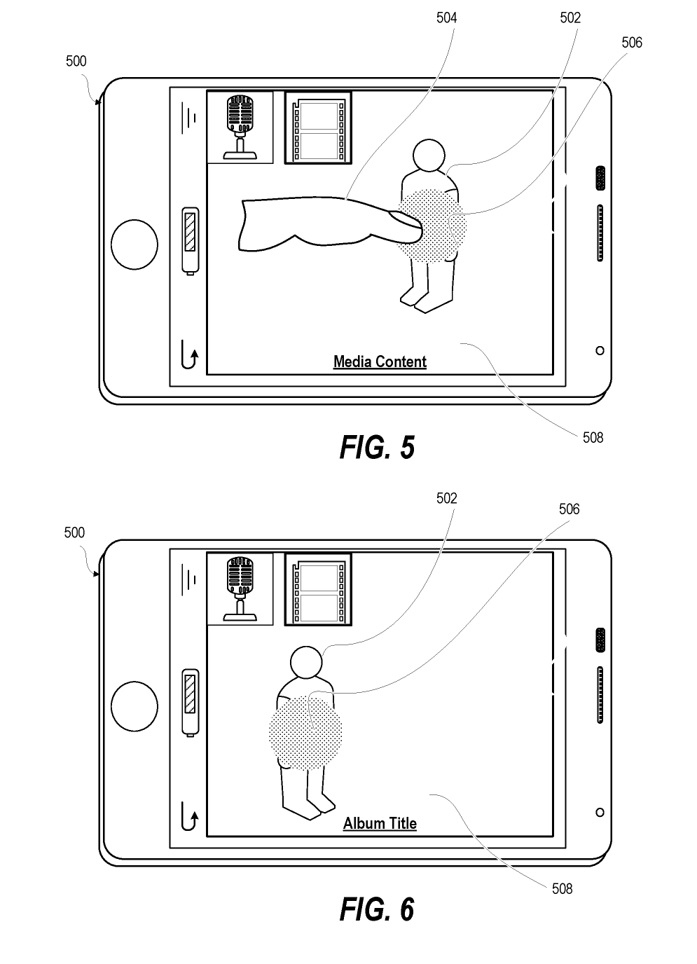

FIGS. 5-6 illustrate an electronic device 500 presenting video content that contains an objectionable image 502 that is tagged by a user 504. Thereafter, the electronic device obscures the image 502 with a dot 506 while the image 502 persists in the media content 508 or is recognized to have reappeared in a later portion or subsequent media content. For example, the user can select a dot of a first color (e.g., red) and drag the dot overtop of the offending static image. The red dot conveys static blocking of the offensive image. For another example, the user can select a dot of a second color (e.g., green) and drag the dot overtop of the offending moving image. The green dot conveys dynamic blocking of the offensive image. In addition to changing location on the screen, the dot can change size or shape to maintain relative blocking of an underlying image that becomes larger or smaller within the field of view of the media content.

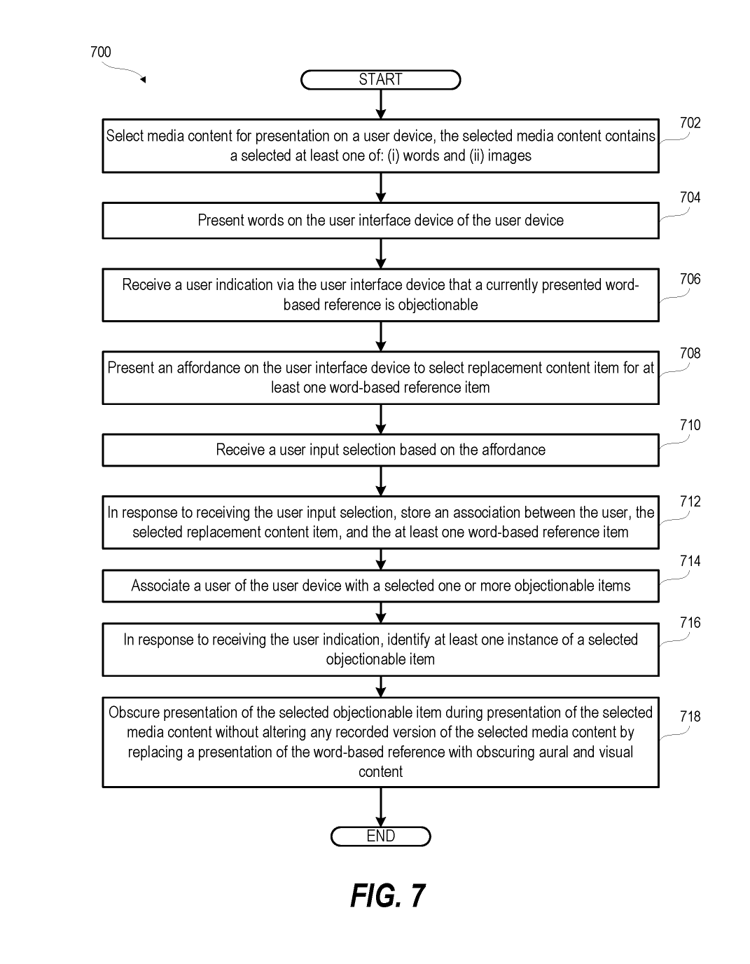

FIG. 7 illustrates a method 700 for customizing content of media according to individual user selections to blur, omit or replace objectionable items, either aurally or visually or both. In one or more embodiments, method 700 includes selecting media content for presentation on a user device, the selected media content contains a selected at least one of: (i) words and (ii) images (block 702). Method 700 includes presenting words on the user interface device of the user device (block 704). Method 700 includes receiving a user indication via the user interface device that a currently presented word-based reference is objectionable (block 706). Method 700 includes presenting an affordance on the user interface device to select replacement content item for at least one word-based reference item (block 708). Method 700 includes receiving a user input selection based on the affordance (block 710). Method 700 includes, in response to receiving the user input selection, storing an association between the user, the selected replacement content item, and the at least one word-based reference item (block 712). Method 700 includes associating a user of the user device with a selected one or more objectionable items (block 714). Method 700 includes, in response to receiving the user indication, identifying at least one instance of a selected objectionable item (block 716). Method 700 includes obscuring presentation of the selected objectionable item during presentation of the selected media content without altering any recorded version of the selected media content by replacing a presentation of the word-based reference with obscuring aural and visual content (block 718). For example, method 700 can utilize replacements of a selected one of: (i) an alternate word; (ii) muting; and (iii) a tonal rendering.

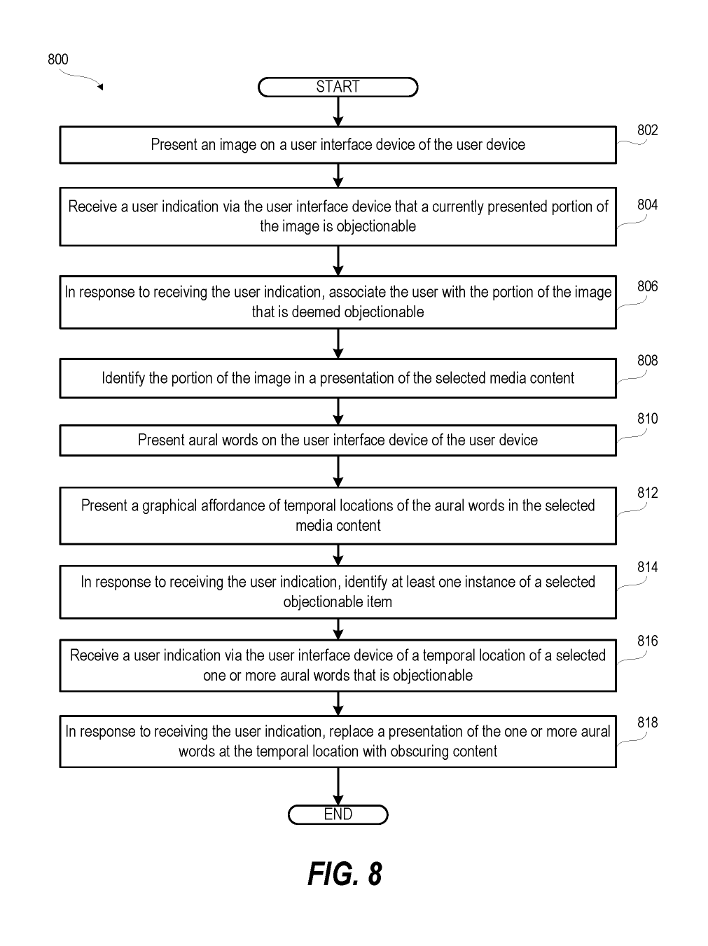

FIG. 8 illustrates a method 800 for further customized presentation of media content without humanly perceptible objectionable items. Method 800 includes presenting an image on a user interface device of the user device (block 802). Method 800 includes receiving a user indication via the user interface device that a currently presented portion of the image is objectionable (block 804). Method 800 includes, in response to receiving the user indication, associating the user with the portion of the image that is deemed objectionable (block 806). Method 800 includes identifying the portion of the image in a presentation of the selected media content (block 808). Method 800 includes obscuring presentation of the identified portion of the image that is deemed objectionable without altering any recorded instances of the selected media content (block 810). Method 800 includes presenting aural words on the user interface device of the user device (block 812). Method 800 includes presenting a graphical affordance of temporal locations of the aural words in the selected media content (block 814). Method 800 includes receiving a user indication via the user interface device of a temporal location of a selected one or more aural words that is objectionable (block 816). Method 800 includes, in response to receiving the user indication, replacing a presentation of the one or more aural words at the temporal location with obscuring content (block 818).

In the above described flow charts of FIGS. 7-8, the methods may be embodied in an automated control system that performs a series of functional processes. In some implementations, certain steps of the methods are combined, performed simultaneously or in a different order, or perhaps omitted, without deviating from the scope of the disclosure. Thus, while the method blocks are described and illustrated in a particular sequence, use of a specific sequence of functional processes represented by the blocks is not meant to imply any limitations on the disclosure. Changes may be made with regards to the sequence of processes without departing from the scope of the present disclosure. Use of a particular sequence is therefore, not to be taken in a limiting sense, and the scope of the present disclosure is defined only by the appended claims.

It must be noted that, as used in this specification and the appended claims, the singular forms “a,” “an” and “the” include plural referents unless the content clearly dictates otherwise. Thus, for example, reference to a “colorant agent” includes two or more such agents.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

As will be appreciated by one having ordinary skill in the art, the methods and compositions of the invention substantially reduce or eliminate the disadvantages and drawbacks associated with prior art methods and compositions.

It should be noted that, when employed in the present disclosure, the terms “comprises,” “comprising,” and other derivatives from the root term “comprise” are intended to be open-ended terms that specify the presence of any stated features, elements, integers, steps, or components, and are not intended to preclude the presence or addition of one or more other features, elements, integers, steps, components, or groups thereof.

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

While it is apparent that the illustrative embodiments of the invention herein disclosed fulfill the objectives stated above, it will be appreciated that numerous modifications and other embodiments may be devised by one of ordinary skill in the art. Accordingly, it will be understood that the appended claims are intended to cover all such modifications and embodiments, which come within the spirit and scope of the present invention.

What is claimed is:

1. A method comprising:
selecting media content for presentation on a user device, the selected media content contains a selected at least one of: (i) words and (ii) images;
associating a user of the user device with a selected one or more objectionable items;
identifying at least one instance of a selected objectionable item; and
obscuring presentation of the selected objectionable item during presentation of the selected media content without altering any recorded version of the selected media content.

2. The method of claim 1, further comprising:
presenting words on the user interface device of the user device;
receiving a user indication via the user interface device that a currently presented word-based reference is objectionable; and
in response to receiving the user indication, replacing a presentation of the word-based reference with obscuring content.

3. The method of claim 2, further comprising:
presenting an affordance on the user interface device to select replacement content item for at least one word-based reference item;
receiving a user input selection based on the affordance; and
in response to receiving the user input selection, storing an association between the user, the selected replacement content item, and the at least one word-based reference item.

4. The method of claim 2, wherein:
the presentation of the selected media content includes an aural presentation of the word-based reference; and
replacing the representation of the word-based reference includes substituting a selected one of: (i) an alternate word; (ii) muting; and (iii) a tonal rendering.

5. The method of claim 1, further comprising:
presenting an image on a user interface device of the user device;
receiving a user indication via the user interface device that a currently presented portion of the image is objectionable; and
in response to receiving the user indication:
associating the user with the portion of the image that is deemed objectionable;
identifying the portion of the image in a presentation of the selected media content; and
obscuring presentation of the identified portion of the image that is deemed objectionable without altering any recorded instances of the selected media content.

6. The method of claim 1, further comprising:
presenting aural words on the user interface device of the user device;
presenting a graphical affordance of temporal locations of the aural words in the selected media content;
receiving a user indication via the user interface device of a temporal location of a selected one or more aural words that is objectionable; and
in response to receiving the user indication, replacing a presentation of the one or more aural words at the temporal location with obscuring content.

7. The method of claim 1, further comprising presenting the selected media content on a selected one of: (i) a smart phone, (ii) a television monitor, (iii) an augmented reality heads up display, (iv) a virtual reality headset, (v) audio headphone, and (vi) a personal computing workstation.

8. An electronic device comprising:
an interface that receives selected media content;
a user interface device that presents selected media content; and
a processor subsystem in communication with the interface and the user interface device, and which:
selects media content for presentation on the user device, the selected media content contains a selected at least one of: (i) words and (ii) images;
associates a user of the user device with a selected one or more objectionable items;
identifies at least one instance of a selected objectionable item; and
obscures presentation of the selected objectionable item during presentation of the selected media content without altering any recorded version of the selected media content.

9. The electronic device of claim 8, wherein the processor subsystem:
presents words on the user interface device of the user device;
receives a user indication via the user interface device that a currently presented word-based reference is objectionable; and
in response to receiving the user indication, replaces a presentation of the word-based reference with obscuring content.

10. The electronic device of claim 9, wherein the processor subsystem:
presents an affordance on the user interface device to select replacement content item for at least one word-based reference item;
receives a user input selection based on the affordance; and
in response to receiving the user input selection, stores an association between the user, the selected replacement content item, and the at least one word-based reference item.

11. The electronic device of claim 9, wherein the processor subsystem:
presents an aural presentation of the word-based reference as part of the selected media content; and
replaces the representation of the word-based reference by substituting a selected one of: (i) an alternate word; (ii) muting; and (iii) a tonal rendering.

12. The electronic device of claim 8, wherein the processor subsystem:
presents an image on a user interface device of the user device;
receives a user indication via the user interface device that a currently presented portion of the image is objectionable; and
in response to receiving the user indication:
associates the user with the portion of the image that is deemed objectionable;
identifies the portion of the image in a presentation of the selected media content; and
obscures presentation of the identified portion of the image that is deemed objectionable without altering any recorded instances of the selected media content.

13. The electronic device of claim 8, wherein the processor subsystem:
presents aural words on the user interface device of the user device;
presents a graphical affordance of temporal locations of the aural words in the selected media content;
receives a user indication via the user interface device of a temporal location of a selected one or more aural words that is objectionable; and
in response to receiving the user indication, replaces a presentation of the one or more aural words at the temporal location with obscuring content.

14. The electronic device of claim 8, further comprising a selected one of: (i) a smart phone, (ii) a television monitor, (iii) an augmented reality heads up display, (iv) a virtual reality headset, (v) audio headphone, and (vi) a personal computing workstation that presents the selected media content.

15. A system comprising:
a network repository that contains: (i) an application store containing a downloadable end user application; and (ii) a database of identified users associated with selections of individually-identified objectionable content;
a network in communication with the network repository and in communication with one or more sources of media content; and
an electronic device of one or more electronic devices associated with a selected user, the electronic device comprising:
an interface that receives via the network: (i) the application from the network repository and (ii) selected media content from a selected source;
a user interface device that presents selected media content; and
a processor subsystem in communication with the interface and the user interface device, and which:
selects media content for presentation on the user device, the selected media content contains a selected at least one of: (i) words and (ii) images;
associates the user of the user device with a selected one or more objectionable items;
identifies at least one instance of a selected objectionable item; and
obscures presentation of the selected objectionable item during presentation of the selected media content without altering any recorded version of the selected media content.

16. The system of claim 15, wherein the processor subsystem of the electronic device:
presents words on the user interface device of the user device;
receives a user indication via the user interface device that a currently presented word-based reference is objectionable; and
in response to receiving the user indication, replaces a presentation of the word-based reference with obscuring content.

17. The system of claim 16, wherein the processor subsystem of the electronic device:
presents an affordance on the user interface device to select replacement content item for at least one word-based reference item;
receives a user input selection based on the affordance; and
in response to receiving the user input selection, stores an association between the user, the selected replacement content item, and the at least one word-based reference item.

18. The system of claim 16, wherein the processor subsystem of the electronic device:
presents an aural presentation of the word-based reference as part of the selected media content; and
replaces the representation of the word-based reference by substituting a selected one of: (i) an alternate word; (ii) muting; and (iii) a tonal rendering.

19. The system of claim 15, wherein the processor subsystem of the electronic device:
presents an image on a user interface device of the user device;
receives a user indication via the user interface device that a currently presented portion of the image is objectionable; and
in response to receiving the user indication:
associates the user with the portion of the image that is deemed objectionable;
identifies the portion of the image in a presentation of the selected media content; and
obscures presentation of the identified portion of the image that is deemed objectionable without altering any recorded instances of the selected media content.

20. The system of claim 15, wherein the processor subsystem of the electronic device:
presents aural words on the user interface device of the user device;
presents a graphical affordance of temporal locations of the aural words in the selected media content;
receives a user indication via the user interface device of a temporal location of a selected one or more aural words that is objectionable; and
in response to receiving the user indication, replaces a presentation of the one or more aural words at the temporal location with obscuring content.
